(19) United States
(12) Patent Application Publication
(10) Pub. No.: US 2008/0295431 A1
(43) Pub. Date: Dec. 4, 2008

(54) Reversible planking system and method for making thereof

(76) Inventor: Pao Yu An, Morris Plains, NJ (US)

Correspondence Address: KENYON & KENYON LLP, ONE BROADWAY, NEW YORK, NY, 10004, US

(21) Appl. No.: 11/809,674

(22) Filed: May 31, 2007

(51) Int. Cl. B44F 9/02

(52) U.S. Cl. 52/313

(57) ABSTRACT

A reversible composite simulated beadboard planking and a method for making the same are provided. The planking may include a first finished side, a second finished side opposite the first finished side, a first pattern including integrally-formed uneven profile simulating a beadboard of a first plank width on the first finished side, a second pattern including integrally-formed uneven profile simulating a beadboard of a second plank width different than the first plank width on the second finished side, a base pigment distributed substantially uniformly throughout the planking, and a tongue structure on a first edge substantially adjacent to the first finished side and the second finished side, and a groove structure on a second edge opposite the first edge, the groove structure configured to receive the tongue structure from another similarly configured composite planking.

### BACKGROUND

Wainscoting is a paneling applied to a lower portion of an interior wall, below a chair rail and above a base molding. It is traditionally constructed from tongue-and-groove panels, for example, cut from wood. Wainscoting was originally intended to cover the lower part of walls which may be affected by rising dampness. Today, wainscoting is generally decorative in purpose.

One method of forming paneling, such as wainscoting, is to press slurry into a mold with the desired shape. Unfortunately, substantial technical difficulties prevent forming a two-sided structure with pressing. In addition, the finished structure must be colored by lamination or painting after its removal from the press, as the high pressure and temperature of the pressing process does not allow coloring during the production process.

Another method of forming paneling, such as wainscoting, is to cut wooden beams into panels. Unfortunately, cutting and trimming wooden beams creates a large amount of saw dust, waste material and blade wear. In addition, inconsistencies in the wooden beams can affect the quality of the finished structures.

A substitute for solid wood paneling is laminates of multiple layers such as plywood. Conventional wooden paneling is particularly ill-suited for locations with dampness, such as bathrooms and kitchens.

Extrusion is a manufacturing process used to create long objects of a fixed cross-sectional profile. A material is pushed or drawn through a die of the desired profile shape. Hollow sections may be extruded by placing a pin or piercing mandrel inside of the die. Extrusion may be continuous (producing indefinitely long material) or semi-continuous (producing a plurality of finite length pieces).

The material may be forced through the die by various methods. A single or twin screw auger, powered by an electric motor, or a ram, driven by hydraulic pressure, oil pressure, or in other specialized processes such as rollers inside a perforated drum for the production of many simultaneous streams of material. Commonly extruded materials include malleable materials such as metals at high temperatures, polymers, ceramics, and foodstuffs.

### BRIEF DESCRIPTION OF THE DRAWINGS

FIG. 1A illustrates a first side of a reversible planking, according to an example embodiment of the present invention.

FIG. 1B illustrates a second side of a reversible planking, according to an example embodiment of the present invention.

FIG. 2 illustrates a profile of a reversible planking, according to an example embodiment of the present invention.

FIG. 3 illustrates a procedure of producing a reversible planking, according to an example embodiment of the present invention.

FIG. 4A illustrates a first chair rail, according to an example embodiment of the present invention.

FIG. 4B illustrates a second chair rail, according to an example embodiment of the present invention.

FIG. 4C illustrates a base molding, according to an example embodiment of the present invention.

### DETAILED DESCRIPTION

A reversible planking may be extruded from a polymer wood composite. The planking may be, for example, wainscoting, base molding, or chair rails. Wainscoting may be a two-sided sheet of reversible planking, narrow beaded on a first side and wide beaded on a second side.

Before extrusion, the polymer wood composite may be mixed with a base pigment for a uniform color planking or a marbling pigment for a marbled color. After extrusion, the planking may be textured with roller drums. Marbling and texturing of the planking may simulate wood grain marbling and texturing. Thus, composite wainscoting simulating wood wainscoting may be manufactured in a one-stop production process, with all steps performed without outside intervention.

This application hereby incorporates by reference U.S. Patent Application Publication 2006/0267238, application Ser. No. 11/142,163 entitled “Polymer Wood Composite Material and Method of Making Same.”

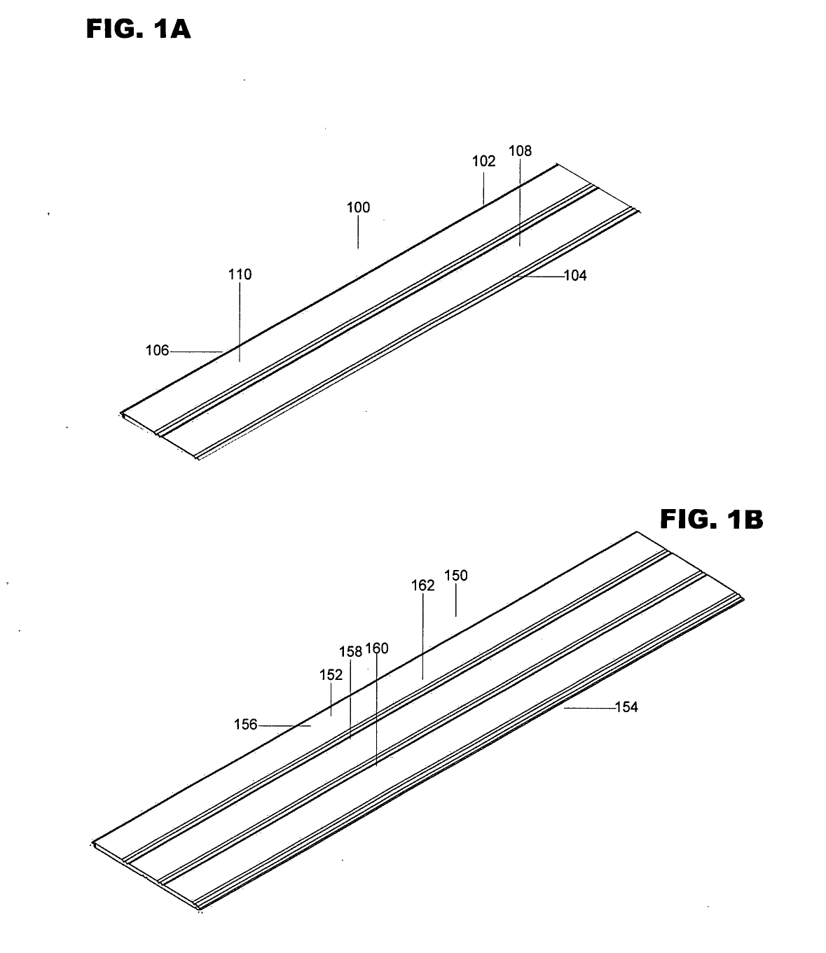

FIG. 1A illustrates a first side of a reversible planking, according to an example embodiment of the present invention. The reversible planking may be wainscoting, or sheets used to panel an interior wall.

The planking 100 may have an uneven profile. For example, the profile of the planking 100 may include protrusions and indentations, and combinations thereof. The planking 100 may include beads 102 and 108. Beads 102 and 108 may be substantially longitudinal indentations and protrusions running the length of the planking 100 and divide the planking 100 into panels. The panels may be colored and textured to simulate a wood panel. The beads 102 and 108 may be substantially parallel.

The planking 100 may include a tongue structure 106 along a first edge and a groove structure 104 along a second opposite edge. The groove structure 104 may be configured to receive a tongue structure of a second similarly configured planking.

The planking 100 may include a first surface 110 and a second surface (depicted in FIG. 1B).

Particularly desirable lengths for the planking 100 may be three feet long and eight feet long. The planking 100 may be 180 mm wide and 6 mm thick, creating a sheet-like plank. The beads 102 and 108 may be 5.8 mm wide. The tongue 106 and the groove may be 8 mm deep.

FIG. 1B illustrates a second side of a reversible planking, according to an example embodiment of the present invention. A planking 150 may be the same as the planking depicted in FIG. 1A, but displaying a second side.

The planking 150 may include beads 152, 158 and 160. Beads 152, 158 and 160 may be substantially longitudinal indentations and protrusions running the length of the planking 150 and divide the planking 150 into panels. The panels may be colored and textured to simulate a wood panel. The beads 152, 158 and 160 may be substantially parallel with beds on a first surface of the planking 150, as depicted in FIG. 1A.

It will be appreciated that other pattern combinations may also be provided on the panel, for example, smooth on both sides, smooth on the first side and beaded on the second side, etc.

The planking 150 may include a tongue structure 156 along a first edge and a groove structure 154 along a second opposite edge. The groove structure 154 may be configured to receive a tongue structure of a second similarly configured planking.

The planking 100 may include a first surface (depicted in FIG. 1A) and a second surface 162. A width of the panels on the second surface 162 may be different from a width of the panels on the first surface.

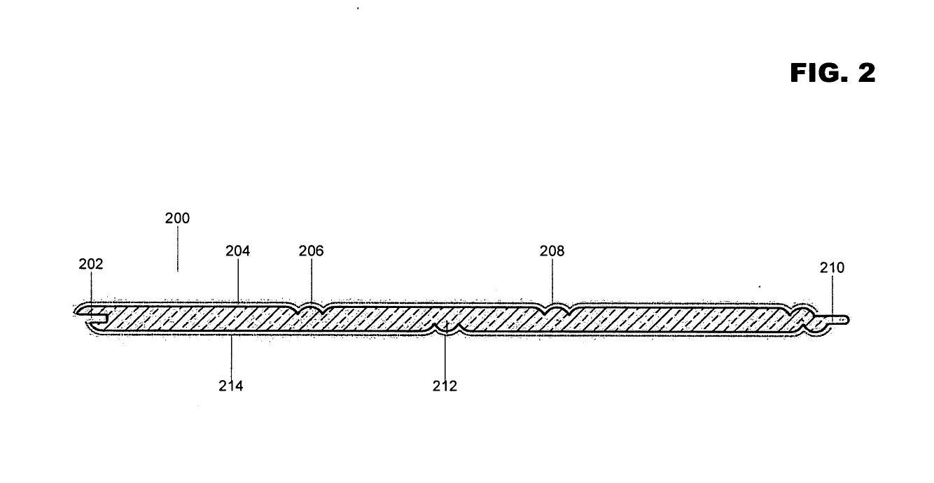

FIG. 2 illustrates a profile of a reversible planking, according to an example embodiment of the present invention. A planking 200 may be as depicted in FIGS. 1A and 1B.

The planking 200 may include a tongue structure 210 along a first edge and a groove structure 202 along a second opposite edge. The groove structure 202 may be configured to receive a tongue structure of a second similarly configured planking. It will be appreciated that other edge structures may also be provided, for example, dovetail, etc.

The planking 200 may include beads 206 and 208 on a first side 204 and bead 212 on a second side 214. Beads 206, 208, and 212 may be substantially longitudinal indentations and protrusions running the length of the planking 200 and divide the planking 200 into panels. The panels may be colored and textured to simulate wood panels. The coloring and texture may be adjusted to simulate different types of wood, for example, oak, pine, spruce, cherry, mahogany, etc. or other types of wood panels. In place of the beads, notched indentations without a bed or multiple beads, or other patterns may be provided.

Alternatively, the panels may be a uniform color, for example, white, and be suitable for painting by an end user.

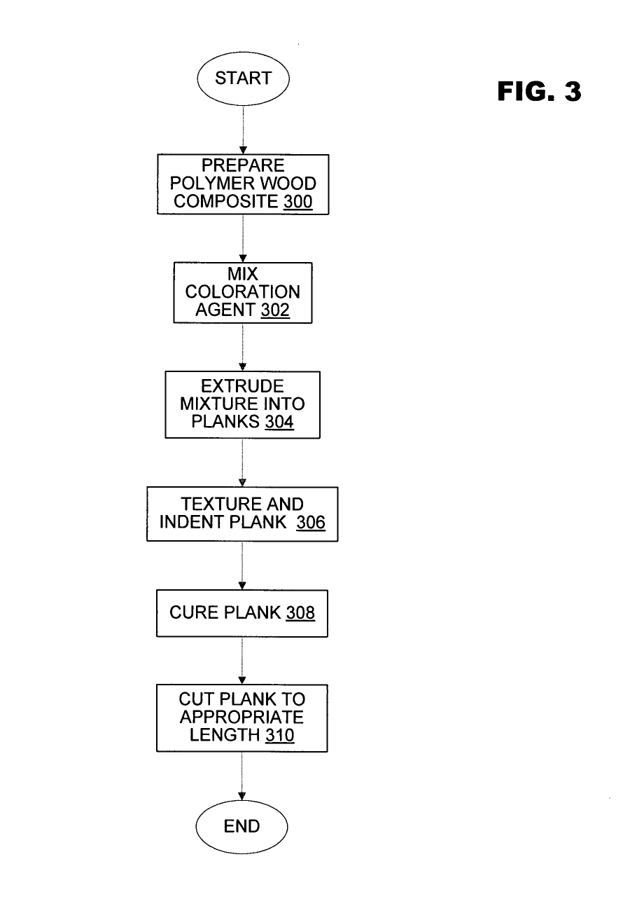

The planking 200 may be suitable for production by extrusion, for example, by the procedure depicted in FIG. 3.

FIG. 3 illustrates a procedure of producing a reversible planking, according to an example embodiment of the present invention. For example, the planking may be as depicted in FIGS. 1A, 1B, 2, 4A, 4B and 4C.

In 300, a polymer wood composite is prepared by mixing base components together. For example, the polymer wood composite may be prepared as described in the Polymer Wood Composite Material and Method of Making Same application, referenced above.

In 302, a coloration agent is mixed into the polymer wood composite, creating an extrudable mixture. The polymer wood composite may include an inherent color, for example, white. In one embodiment, the planking may be subsequently painted by an end-user to a desired color.

The coloration agent may be a base pigment distributed substantially uniformly throughout the mixture. This provides the planking with a uniform color, such as yellow or brown.

Optionally, a second pigment may be marbled substantially throughout the mixture. The marbling may create a marbled coloring simulating a wood grain. Example coloration agents and pigments may include PE flush phthalocyanine, EVA, and PE flush quinacridone.

An example second pigment may include iron oxide yellow and iron oxide red to create a marbling simulating a wood grain of oak. Another example second pigment may include iron oxide red and carbon black to simulate a wood grain of mahogany.

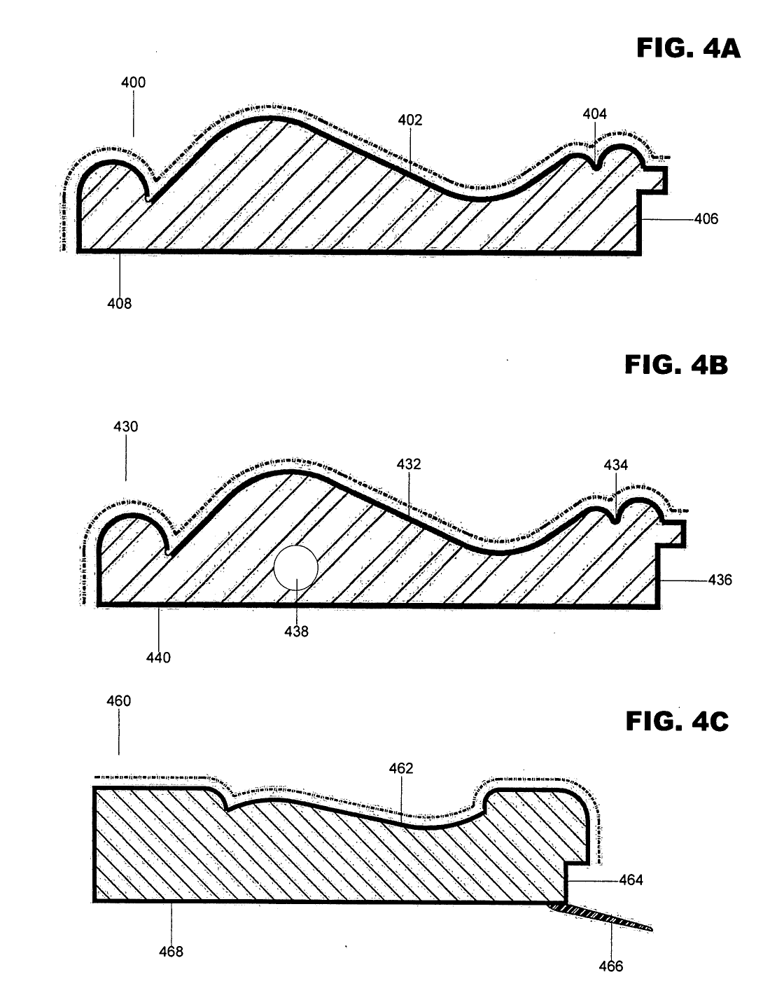

In 304, the mixture is extruded into planks through an extrusion process. For example, the mixture may be pressed by a hydraulic press against a die with a desired cross-section. The cross-section may be as depicted in FIGS. 2, 4A, 4B, and 4C.

In 306, the planking may be textured and indentations may be formed on the surface of the planking. For example, indentations and protrusions may be formed by notching the die used in 304.

The indentations may also include a tongue and groove structure on the planking as depicted in FIGS. 1A, 1B, and 2.

Texturing may also be provided by feeding the uncured planking into a two-sided textured drum roller after extrusion, imprinting the planking with a corresponding texture. For example, the texture may be configured to simulate a wood grain.

It should be appreciated that alternative patterns of texturing and indentation may be used.

In 308, the planking may be cured. For example, the planking may be cooled to room temperature by submerging the planking in 55 degree Fahrenheit water for eight hours, heated to a high temperature, have its moisture removed, or any other curing process. For example, curing may be conducted as described in the Polymer Wood Composite Material and Method of Making Same application, referenced above.

In 310, the planking may be cut to an appropriate length. For example, the planking may be three feet long for paneling a lower portion of the interior wall, or eight feet long for paneling a large portion of the interior wall. Uncured extruded material may be cut to those lengths.

In an alternative embodiment, the planking may be cut before it is allowed to cure.

FIG. 4A illustrates a first chair rail, according to an example embodiment of the present invention. A chair rail 400 may be a planking produced by the procedure depicted in FIG. 3. The chair rail 400 may include an exposed surface 402 configured to be displayed, one or more grooves 404 and notches 406 formed during the extrusion process, and a surface 408 configured to be mounted against a flat wall.

Particularly desirable lengths for the chair rail 400 may be eight feet long. The chair rail 400 may be cut by an end user to a desired length. The chair rail 400 may be 67 mm wide and 15.1 mm thick. The notch 406 may be 6 mm wide and 3 mm deep.

FIG. 4B illustrates a second chair rail, according to an example embodiment of the present invention. A chair rail 430 may be a planking produced by the procedure depicted in FIG. 3 and similar to the chair rail depicted in FIG. 4A. The chair rail 430 may include an exposed surface 432 configured to be displayed, one or more grooves 434 and notches 436 formed during the extrusion process, and a surface 440 configured to be mounted against a flat wall.

The chair rail 430 may also include a hole 438 configured to enclose a wire or cable or any other object. For example, the chair rail 430 may provide an access hole through which a wire or cable may be run, thus eliminating the need to mount the chair rail over the wire or cable on the wall.

FIG. 4C illustrates a base molding, according to an example embodiment of the present invention. A base molding 460 may be a planking produced by the procedure depicted in FIG. 3. The chair rail 460 may include an exposed surface 162 configured to be displayed, one or more notches 464 formed during the extrusion process, and a surface 468 configured to be mounted against a flat wall.

The base molding 460 may also include a weather seal 466. The weather seal 466 may be waterproof and be configured to adhere to a flat surface, such as a wall on which the base molding 460 is mounted.

Particularly desirable lengths for the base molding 460 may be eight feet long. The base molding 460 may be cut by an end user to a desired length. The base molding 460 may be 66.7 mm wide and 15 mm thick. The notch 464 may be 6 mm wide and 3 mm deep.

An extrudable reversible planking manufactured from a polymer wood composite is useful for a variety of applications, such as wainscoting, base molding, or chair rails. Sheets may be extruded with integral beads and simulate wood grain through texturing and marbled coloring in a one-stop production process, reducing production cost and time. Chair rails and base moldings may be packaged and sold together with panels in a unifying container, for example, a box packaging or a display.

An example embodiment of the present invention may be a reversible composite simulated beadboard planking, including a first finished side, a second finished side opposite the first finished side, a first pattern including integrally-formed uneven profile simulating a beadboard of a first plank width on the first finished side, a second pattern including integrally-formed uneven profile simulating a beadboard of a second plank width different than the first plank width on the second finished side, a base pigment distributed substantially uniformly throughout the planking, and a tongue structure on a first edge substantially adjacent to the first finished side and the second finished side, and a groove structure on a second edge opposite the first edge, the groove structure configured to receive the tongue structure from another similarly configured composite planking.

Another example embodiment of the present invention may be a composite planking, including a first finished side, a second finished side opposite the first finished side, a first pattern including integrally-formed uneven profile on the first finished side, and a second pattern including integrally-formed uneven profile on the second finished side, the second pattern different than the first pattern. The planking may be sheet-like and has a thickness substantially less than a length and a width. The first pattern and the second pattern may simulate beadboards of a first and a second plank widths. The uneven profile on the first finished side and the uneven profile on the second finished side may be substantially parallel with each other. A simulated wood grain texture may be integrally formed on at least one of the finished sides. A base pigment may be distributed substantially uniformly throughout the planking. A second pigment different from the base pigment may be marbled substantially throughout the planking, wherein the marbling simulates a wood grain coloring. The planking may further include a tongue structure on a first vertical edge, and a groove structure on a second vertical edge opposite the first vertical edge, the groove structure configured to receive the tongue structure from another similarly configured composite planking. The composite planking may be manufactured by extrusion. The composite planking may be composed from a polymer wood composite material.

Another example embodiment of the present invention may be a composite article, including an extruded reversible planking, the planking including a polymer wood composite material and a base coloration agent substantially distributed throughout the compound. The base coloration agent may be substantially uniformly distributed throughout the compound. The composite article may further include a second coloration agent simulating a marbled wood grain color. Uneven profile may be formed on the planking to product a first pattern of integrally-formed uneven profile on a first side and a second pattern of integrally-formed uneven profile on a second side. The planking may be textured prior to curing to produce a simulated wood grain texture on a first side and a second side.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should be understood that there exist implementations of other variations, combinations, and modifications of the invention and its various aspects, as may be readily apparent to those of ordinary skill in the art, and that the invention is not limited by specific embodiments described herein. It is therefore contemplated to cover any and all modifications, combinations, variations or equivalents that fall within the scope of the basic underlying principals disclosed and claimed herein.

We claim:

1. A reversible composite simulated beadboard planking, comprising:
a first finished side;
a second finished side opposite the first finished side;
a first pattern including integrally-formed uneven profile simulating a beadboard of a first plank width on the first finished side;
a second pattern including integrally-formed uneven profile simulating a beadboard of a second plank width different than the first plank width on the second finished side;
a base pigment distributed substantially uniformly throughout the planking; and
a tongue structure on a first edge substantially adjacent to the first finished side and the second finished side, and a groove structure on a second edge opposite the first edge, the groove structure configured to receive the tongue structure from another similarly configured composite planking.

2. A composite planking, comprising:
a first finished side;
a second finished side opposite the first finished side;
a first pattern including integrally-formed uneven profile on the first finished side; and
a second pattern including integrally-formed uneven profile on the second finished side, the second pattern different than the first pattern.

3. The composite planking of claim 2, wherein the planking is sheet-like and has a thickness substantially less than a length and a width.

4. The composite planking of claim 2, wherein the first pattern and the second pattern simulate beadboards of a first and a second plank widths.

5. The composite planking of claim 2, wherein the uneven profile on the first finished side and the uneven profile on the second finished side are substantially parallel with each other.

6. The composite planking of claim 2, wherein a simulated wood grain texture is integrally formed on at least one of the finished sides.

7. The composite planking of claim 2, including a base pigment distributed substantially uniformly throughout the planking.

8. The composite planking of claim 7, including a second pigment different from the base pigment marbled substantially throughout the planking, wherein the marbling simulates a wood grain coloring.

9. The composite planking of claim 2, further including
a tongue structure on a first vertical edge, and a groove structure on a second vertical edge opposite the first vertical edge, the groove structure configured to receive the tongue structure from another similarly configured composite planking.

10. The composite planking of claim 2, wherein the composite planking is manufactured by extrusion.

11. The composite planking of claim 2, wherein the composite planking is composed from a polymer wood composite material.

12. A composite article, comprising:
an extruded reversible planking, the planking including a polymer wood composite material and a base coloration agent substantially distributed throughout the compound.

13. The composite article of claim 12, wherein the base coloration agent is substantially uniformly distributed throughout the compound.

14. The composite article of claim 12, further including a second coloration agent simulating a marbled wood grain color.

15. The composite article of claim 12, wherein uneven profile are formed on the planking to product a first pattern of integrally-formed uneven profile on a first side and a second pattern of integrally-formed uneven profile on a second side.

16. The composite article of claim 12, wherein the planking is textured prior to curing to produce a simulated wood grain texture on a first side and a second side.
